(19) United States
(12) Patent Application Publication
(10) Pub. No.: US 2021/0004385 A1
(43) Pub. Date: Jan. 7, 2021

(54) SYSTEM AND METHOD FOR ANALYSIS OF ONE OR MORE UNSTRUCTURED DATA

(71) Applicant: Gangadharan Vijayalakshmi, Chennai (IN)

(72) Inventors: Gangadharan Vijayalakshmi, Chennai (IN); Neelameghan Muralidharan, Chennai (IN)

(21) Appl. No.: 16/685,259

(22) Filed: Nov. 15, 2019

(30) Foreign Application Priority Data
Jul. 5, 2019 (IN) 201941027040

(51) Int. Cl. G06F 16/25; G06F 16/28

(52) U.S. Cl. CPC G06F 16/258; G06F 16/28

(57) ABSTRACT

A system for analysis of one or more unstructured data is disclosed. The system includes a data processing subsystem. The data processing subsystem includes a data retrieving module, configured to retrieve the one or more unstructured data of a plurality of file formats. The data processing subsystem also includes a data conversion module, configured to deduce the one or more unstructured data of the plurality of file formats, to analyse the one or more unstructured data of the plurality of file formats by an analysing technique and to convert the one or more unstructured data of the plurality of file formats after analysis to a structured data output in real time. The data processing subsystem also includes a data exception handling module, configured to identify data exceptions related the structured data output and configured to handle data exceptions related the structured data output. The system provides proper structured output.

This Application claims priority from a complete patent application filed in India having Patent Application No. 201941027040, filed on Jul. 5, 2019 and titled “SYSTEM AND METHOD FOR ANALYSIS OF ONE OR MORE UNSTRUCTURED DATA”.

### FIELD OF INVENTION

Embodiments of a present disclosure relates to analysis of large text data, and more particularly to system for analysis of one or more unstructured data using various analytical techniques.

### BACKGROUND

Most challenging problem is managing a large and growing collections of text and image information and unstructured data originating from various industrial entities that are either disparate, connected or disconnected systems. Data repositories aggregates data usually from multiple sources or segments of a business. Organising, exploring and analysing an over-whelming amount of data is a very difficult work. As the number of documents increases, learning the meaning of the text corpora becomes cognitively costly and time consuming.

In one approach, a system uses various algorithm techniques to organise and explore a collection of unstructured data. The unstructured data may be combination of various data types. More efficient approach would be to organise data corresponding to various file format. In every subject domain, enormous data corresponding to various file format are used, and here, the first important point is to organise those enormous data. Providing data exception handling mechanism for all the anomalies created during data capture followed by exception analysis will increase efficiency of the known system.

Hence, there is a need for an improved system for analysis of one or more unstructured data and a method to operate the same and therefore address the aforementioned issues.

### BRIEF DESCRIPTION

In accordance with one embodiment of the disclosure, a system for analysis of one or more unstructured data is provided. The system includes a data processing subsystem. The data processing subsystem includes a data retrieving module. The data retrieving module is configured to retrieve the one or more unstructured data of a plurality of file formats

The data processing subsystem also includes a data conversion module. The data conversion module is operatively coupled to the data retrieving module. The data conversion module is configured to deduce the one or more unstructured data of the plurality of file formats. The data conversion module is also configured to analyse the one or more unstructured data of the plurality of file formats by an analysing technique. The data conversion module is also configured to convert the one or more unstructured data of the plurality of file formats after analysis to a structured data output in real time.

The data processing subsystem also includes a data exception handling module. The data exception handling module is operatively coupled to the data conversion module. The data exception handling module is configured to identify data exceptions related the structured data output. The data exception handling module is also configured to handle data exceptions related the structured data output

A data memory subsystem is operatively coupled to data processing subsystem. The data memory subsystem is configured to store the one or more unstructured data of a plurality of file formats and the corresponding structured data output. Here, the memory subsystem is located on a blockchain platform.

In accordance with one embodiment of the disclosure, the method for analysis of one or more unstructured data is provided. The method includes retrieving one or more unstructured data of a plurality of file formats. The method also includes deducing the one or more unstructured data of the plurality of file formats. The method also includes analysing the one or more unstructured data of the plurality of file formats by an analysing technique.

The method also includes converting the one or more unstructured data of the plurality of file formats after analysis to a structured data output in real time. The method also includes identifying data exceptions related the structured data output. The method also includes handling the data exceptions related the structured data output.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system for analysis of one or more unstructured data in accordance with an embodiment of the present disclosure;

FIG. 2 is a schematic representation of an embodiment representing the system for analysis of the one or more unstructured data of FIG. 1 in accordance of an embodiment of the present disclosure;

FIG. 3 is a block diagram of a computer or a server in accordance with an embodiment of the present disclosure; and

FIG. 4 is a flowchart representing the steps of a method for analysis of one or more unstructured data in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated online platform, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, subsystems, elements, structures, components, additional devices, additional subsystems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system for analysis of one or more unstructured data. The system includes a data processing subsystem. The data processing subsystem includes a data retrieving module. The data retrieving module is configured to retrieve the one or more unstructured data of a plurality of file formats.

The data processing subsystem also includes a data conversion module. The data conversion module is operatively coupled to the data retrieving module. The data conversion module is configured to deduce the one or more unstructured data of the plurality of file formats. The data conversion module is also configured to analyse the one or more unstructured data of the plurality of file formats by an analysing technique. The data conversion module is also configured to convert the one or more unstructured data of the plurality of file formats after analysis to a structured data output in real time.

The data processing subsystem also includes a data exception handling module. The data exception handling module is operatively coupled to the data conversion module. The data exception handling module is configured to identify data exceptions related the structured data output. The data exception handling module is also configured to handle data exceptions related the structured data output.

A data memory subsystem is operatively coupled to data processing subsystem. The data memory subsystem is configured to store the one or more unstructured data of a plurality of file formats and the corresponding structured data output. Here, the data memory subsystem is located on a blockchain platform.

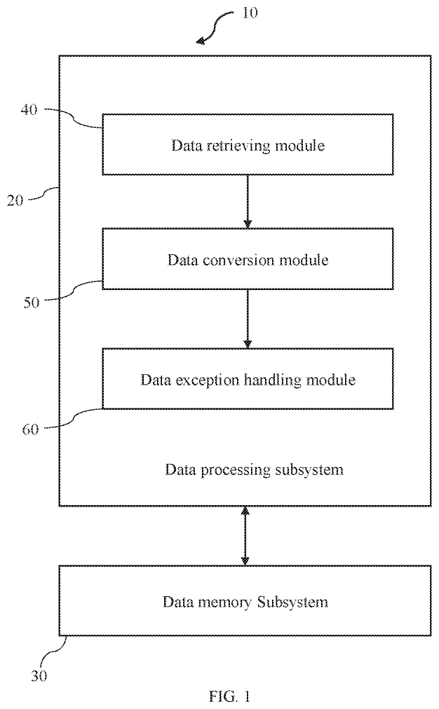

FIG. 1 is a block diagram representation of a system for analysis of one or more unstructured data 10 in accordance with an embodiment of the present disclosure. As used herein, the term “unstructured data” is information that either does not have a pre-defined data model or is not organized in a pre-defined manner. In one embodiment, the unstructured data may be of a plurality of file formats. As used herein, the term “file format” is a standard way by which information is encoded for storage in a computer file.

The system 10 includes a data processing subsystem 20. The data processing subsystem 20 includes a data retrieving module 40. The data retrieving module 40 is configured to retrieve the one or more unstructured data of the plurality of file formats.

In one embodiment, the plurality of file formats may be of domains like related to scientific data, financial records, security and the like. In another embodiment, the plurality of file formats may be of PDF (Portable document format), word document, excel document and the like.

Furthermore, in one exemplary embodiment, the data retrieving module 40 may retrieve two excel documents related to same domain. In such exemplary embodiment, the two excel documents, may contain different number of rows and number of columns arranged data.

The data processing subsystem 20 also includes a data conversion module 50. The data conversion module 50 is operatively coupled to the data retrieving module 40. The data conversion module 50 is configured to deduce the one or more unstructured data of the plurality of file formats.

Further, the data conversion module 50 is configured to analyse the one or more unstructured data of the plurality of file formats by an analysing technique. In one embodiment, analysing technique applied to the unstructured data comprises one of a statistical algorithm technique, machine learning technique, natural language processing technique, text mining technique and the like.

In one embodiment, statistical algorithms technique uses statistical methods such as mathematical formulae, models, and techniques in analysis of raw data. As used herein, “machine learning technique” refers to an application of artificial intelligence (AI) that provides systems the ability to automatically learn and improve from experience without being explicitly programmed.

Furthermore, in one embodiment, the term “natural language processing technique” refers to application of computational techniques to the analysis and synthesis of natural language and speech. In another embodiment, the “text mining technique” refers to the process of deriving high-quality information from text.

The data conversion module 50 is also configured to convert the one or more unstructured data of the plurality of file formats after analysis to a structured data output in real time. As used herein, the term “structured data” is data that has been organized into a business process industry formatted repository, typically a database, so that database elements can be made addressable for more effective machine learning processing and analysis.

In continuation of the earlier exemplary embodiment, the analysing techniques such as natural language processing and text mining are being used to analyse the two excel document that was retrieved by the data retrieval module 40. Here, the text in every column and every row are analysed by the mentioned techniques for providing a structured data output.

The data processing subsystem 20 also includes a data exception handling module 60. The data exception handling module 60 is operatively coupled to the data conversion module 50. The data exception handling module 60 is configured to identify data exceptions related the structured data output, in one embodiment, the data exceptions refer to anomalous or exceptional conditions requiring special processing.

The data exception handling module 60 is also configured to handle data exceptions related the structured data output. In one embodiment, the handling of data exceptions may enable by human activities or robotic applications techniques.

It would be appreciated by those skilled in the art that the handling of data exception by human should be minimized for automation profit. In such embodiment, the robotic applications techniques refer to an application that runs automated tasks (scripts) over the internet.

Further, the system 10 comprises a data evaluation module. The data evaluation module is configured to collect converted structured output. The converted structured output is stored or archived for further use.

A data memory subsystem 30 is operatively coupled to the data processing subsystem 20. The data memory subsystem 30 is configured to store the one or more unstructured data of a plurality of file formats and the corresponding structured data output.

In one embodiment, the data memory subsystem 30 is located on a blockchain platform. As used herein, the term “blockchain” refers to a decentralized, distributed and public digital ledger that is used to record transactions across many computers so that any involved record cannot be altered retroactively, without the alteration of all subsequent blocks.

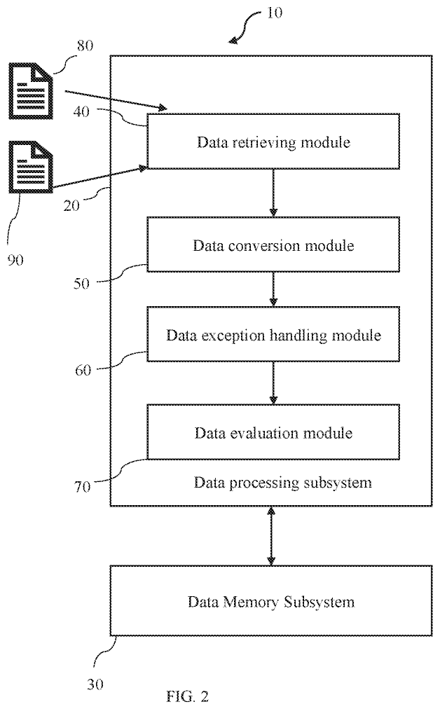

FIG. 2 is a schematic representation of an embodiment representing the system for analysis of the one or more unstructured data 10 of FIG. I in accordance of an embodiment of the present disclosure. For example, a user X provides to the system two medical test results of two different years. First year test result is in Portable document format (PDF) format 80. While another, the second-year test result is in an excel document 90.

A data retrieving module 40 in the system retrieves both the document 80, 90. A data conversion module 50 uses natural language processing technique and text mining technique to understand the data present in both the documents 80, 90 and provide a structured document result.

In one such exemplary embodiment, a probabilistic technique is applied on the textual data of the two documents 80, 90. Such technique enables extraction of a set of semantically meaningful topics that collectively describe all or a portion of the textual data. Further, a topic ordering technique is executed on the said two documents 80, 90 for distributing all or a portion of the textual data across multiple topics. As used herein, the term “topic ordering technique” refers to any topic sorting technique. Subsequently, deep computing and statistical algorithms technique, may be used to identify various themes, topics, emerging issues, and the like within each data set and representation for each of the same is provided. A data evaluation module 70 may use the representation as provided by the data conversion module.

Moreover, during any confusion over the data present in the excel document 90 or pdf format 80 document, the data exception handling module may ask for human interference for solving. Lastly, a structured data representation is formed in real time for better understanding.

In one such exemplary embodiment, the combined result for both years will be provided under appropriate headings. Such structured outputs enable quick understanding of the provided documents,

The data retrieval module 40, the data conversion module 50 and the data exception handling module 60 in FIG. 2 is substantially equivalent to the data retrieval module 40, the data conversion module 50 and the data exception handling module 60 of FIG. 1.

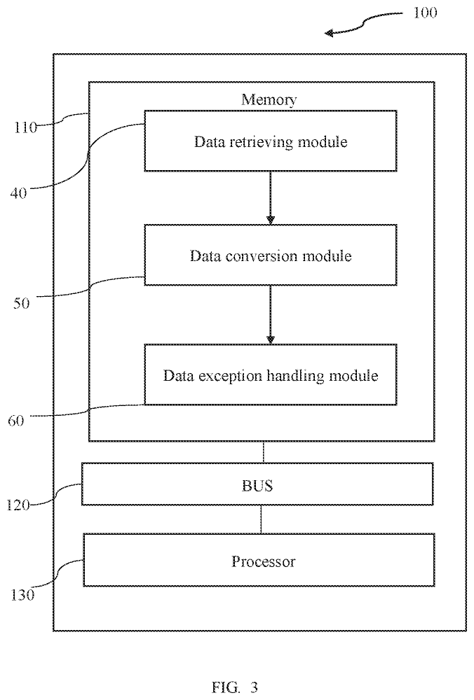

FIG. 3 is a block diagram of a computer or a server 100 in accordance with an embodiment of the present disclosure. The server 100 includes processor(s) 130, and memory 110 coupled to the processor(s) 130.

The processor(s) 130, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof

The memory 110 includes a plurality of modules stored in the form of executable program which instructs the processor 130 to perform the method steps illustrated in FIG. 1. The memory 110 has following modules: the data retrieval module 40, the data conversion module 50 and the data exception handling module 60. The data retrieving module 40 is configured to retrieve the one or more unstructured data of a plurality of file formats. The data conversion module 50 is deduce the one or more unstructured data of the plurality of file formats, further configured to analyse the one or more unstructured data of the plurality of file formats by an analysing technique, and lastly configured to convert the one or more unstructured data of the plurality of file formats after analysis to a structured data output in real time.

The data exception handling module 60 is configured to identify data exceptions related the structured data output and configured to handle data exceptions related the structured data output.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) 130.

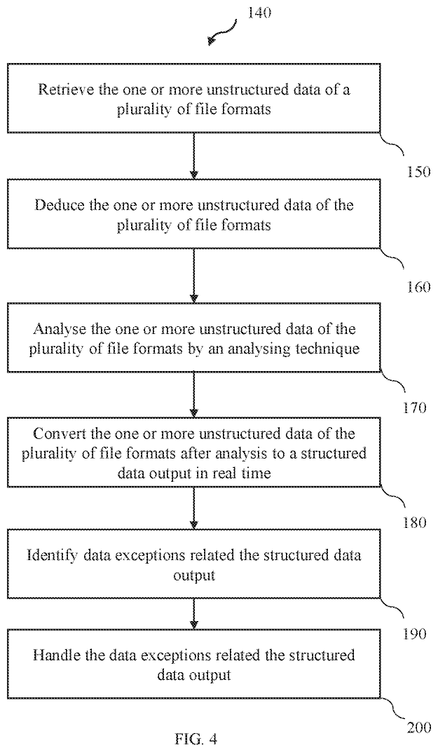

FIG. 4 is a flowchart representing the steps of a method for analysis of one or more unstructured data 140 in accordance with an embodiment of the present disclosure. The method 140 includes retrieving the one or more unstructured data of the plurality of file formats in step 150. In one embodiment, retrieving the one or more unstructured data of the plurality of file formats includes retrieving the one or more unstructured data of the plurality of file formats by a data retrieving module.

The method 140 also includes deducing the one or more unstructured data of the plurality of file formats in step 160. In one embodiment, deducing the one or more unstructured data of the plurality of file formats includes deducing the one or more unstructured data of the plurality of file formats by a data conversion module.

The method 140 also includes analysing the one or more unstructured data of the plurality of file formats by an analysing technique in step 170, in one embodiment, analysing the one or more unstructured data of the plurality of file formats by an analysing technique includes analysing the one or more unstructured data of the plurality of file formats by the data conversion module.

The method 140 also includes converting the one or more unstructured data of the plurality of file formats after analysis to a structured data output in real time in step 180. In one embodiment, converting the one or more unstructured data of the plurality of file formats after analysis to the structured data output in real time includes converting the one or more unstructured data of the plurality of file formats after analysis to the structured data output in real time by the data conversion module.

The method 140 also includes identifying data exceptions related the structured data output in step 190. In one embodiment, identifying the data exceptions related the structured data output includes identifying the data exceptions related the structured data output by a data exception handling module.

The method 140 also includes handling the data exceptions related the structured data output in step 200. In one embodiment, handling the data exceptions related the structured data output includes handling the data exceptions related the structured data output by the data exception handling module.

The method 140 further comprising storing the one or more unstructured data of a plurality of file formats and the corresponding structured data output. In one embodiment, storing the one or more unstructured data of a plurality of file formats and the corresponding structured data output includes storing the one or more unstructured data of a plurality of file formats and the corresponding structured data output by a data memory subsystem.

In another embodiment, storing the one or more unstructured data of a plurality of file formats and the corresponding structured data output includes storing the one or more unstructured data of a plurality of file formats and the corresponding structured data output comprises storing in on a blockchain platform.

Present disclosure of a system for analysis of one or more unstructured data uses various algorithm techniques to organise and explore a collection of unstructured data. Here, the efficiency increases as anomalies are handled automatically or with human interactions. The major advantage is to organise unstructured data present over different file formats.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependant on other acts may be performed in parallel with the other acts. The scope of embodiments is by no means limited by these specific examples.

We claim:

1. A system for analysis of one or more unstructured data, comprising:
a data processing subsystem, comprising:
a data retrieving module configured to retrieve the one or more unstructured data of a plurality of file formats;
a data conversion module operatively coupled to the data retrieving module, and configured
deduce the one or more unstructured data of the plurality of file formats;
analyse the one or more unstructured data of the plurality of file formats by an analysing technique;
convert the one or more unstructured data of the plurality of file formats after analysis to a structured data output in real time;
a data exception handling module operatively coupled to the data conversion module, and configured
identify data exceptions related the structured data output;
handle data exceptions related the structured data output; and
a data memory subsystem operatively coupled to data processing subsystem, and configured to store the one or more unstructured data of a plurality of file formats and the corresponding structured data output, wherein the memory subsystem is located on a blockchain platform.

2. The system as claimed in claim 1, wherein the one or more unstructured data comprises the data corresponding to a plurality of subject domain.

3. A method for analysis of one or more unstructured data, comprising:
retrieving, by a data retrieving module, one or more unstructured data of a plurality of file formats;
deducing, by a data conversion module, the one or more unstructured data of the plurality of file formats;
analysing, by the data conversion module, the one or more unstructured data of the plurality of file formats by an analysing technique;
converting, by the data conversion module, the one or more unstructured data of the plurality of file formats after analysis to a structured data output in real time;
identifying, by a data exception handling module, data exceptions related the structured data output;
handling, by the data exception handling module, the data exceptions related the structured data output;

4. The method as claimed in claim 3, wherein retrieving, by the data retrieving module, the one or more unstructured data comprises the data corresponding to a plurality of subject domain.

5. The method as claimed in claim 3, further comprising storing, by a memory subsystem, the one or more unstructured data of a plurality of file formats and the corresponding structured data output.

6. The method as claimed in claim 5, wherein storing the one or more unstructured data of a plurality of file formats and the corresponding structured data output comprises storing on a blockchain platform.
